(19) United States
(12) Patent Application Publication
(10) Pub. No.: US 2025/0365571 A1
(43) Pub. Date: Nov. 27, 2025

(54) METHOD OF OBTAINING A CAPABILITY FOR A MULTI-ANTENNA TRANSMITTER AND RECEIVER ARRANGEMENT, A COMPUTER PROGRAM PRODUCT, A NON-TRANSITORY COMPUTER-READABLE STORAGE MEDIUM, A WIRELESS DEVICE, AND A TRANSCEIVER NODE

(71) Applicant: BEAMMWAVE AB, Lund (SE)

(72) Inventors: Joakim Axmon, Limhamn (SE); Bengt Lindoff, Bjärred (SE)

(21) Appl. No.: 18/872,686

(22) PCT Filed: May 17, 2023
(86) PCT No.: PCT/SE2023/050490

§ 371 Date: Dec. 6, 2024

(30) Foreign Application Priority Data
Jun. 10, 2022 (SE) 2230191-5

(51) Int. Cl. H04W 8/22; H04B 7/06; H04L 5/00; H04W 76/15

(52) U.S. Cl. CPC H04W 8/22; H04B 7/0696; H04L 5/0041; H04W 76/15

(57) ABSTRACT

A method for a wireless device, WD, or a transceiver node, TNode, comprising a multi-antenna transmitter and receiver arrangement, the method comprising: receiving a request to transmit a capability report comprising a capability of the multi-antenna transmitter and receiver arrangement; obtaining the requested capability, the requested capability indicative of a first or second spatio-temporal dispersion the WD or TNode is able to manage, the first spatio-temporal dispersion being smaller than the second spatio-temporal dispersion; and transmitting the capability report comprising the obtained capability. Corresponding computer program product, wireless device, and transceiver node are also disclosed.

### TECHNICAL FIELD

The present disclosure relates to a method of obtaining a capability for a multi-antenna transmitter and receiver arrangement, a computer program product, a non-transitory computer-readable storage medium, a wireless device, and a transceiver node.

More specifically, the disclosure relates to a method of obtaining a capability for a multi-antenna transmitter and receiver arrangement, a computer program product, a non-transitory computer-readable storage medium, a wireless device, and a transceiver node as defined in the introductory parts of the independent claims.

### BACKGROUND ART

Presently, e.g., in the millimetre wave frequency range, there are three basic multiple-input multiple-output (MIMO) and beamforming (BF) transceiver architectures:

Analog BF, in which the radio signals from/to antennas are combined in the analog domain. This architecture may have problems, such as slow beam tracking, and that there is no channel knowledge per antenna, as only the combined channel is known. An example of analog BF can be found in US 2021/050893 A1.

Hybrid BF, in which radio signals of a subset of antennas is combined in the analog domain to combined streams and the combined streams are analog-to-digital (AD) converted and further combined in the digital domain for reception and in which signals are processed in the digital domain before digital-to-analog (DA) converted and thereafter further processed in the analog domain for transmission. An example of hybrid BF can be found in U.S. Pat. No. 9,319,124 B2.

Digital BF, in which all streams are AD converted and combined in the digital domain for reception and in which signals are processed in the digital domain before DA conversion (and no processing is performed in the analog domain) for transmission. In digital BF there is full channel knowledge for all antennas. However, processing may be very complex and/or power consuming, e.g., if the number of antennas is large. An example of digital BF can be found in U.S. Pat. No. 9,054,845 B2.

As digital BF in theory is capable of handling an infinite number of directions, while analog BF can only handle a single direction and hybrid BF typically can handle the same number of directions as the number of transceivers, digital BF is able to handle more complex radio channels, such as non-Line-of-Sight, than analog BF and hybrid BF.

Hence, depending on the radio channel characteristics the performance may differ between analog, hybrid, and digital BF, and in order to achieve higher or optimal capacity there may be a need for a method and an apparatus in transceiver nodes informing each other about the performance or capability of the respective transceiver nodes, e.g., as different transceiver nodes may have different capabilities.

U.S. Pat. No. 10,631,159 B2 discloses that a user equipment (UE) reports antenna capability information of the UE, and EP 2847957 B1 discloses a communication method and an apparatus using analog and digital hybrid beamforming.

However, there may be a need for improved or alternative methods of informing other transceiver nodes about the performance (or capability).

### SUMMARY

An object of the present disclosure is to mitigate, alleviate or eliminate one or more of the above-identified deficiencies and disadvantages in the prior art and solve at least the above-mentioned problem.

According to a first aspect there is provided a method for a wireless device (WD) or a transceiver node (TNode) comprising a multi-antenna transmitter and receiver arrangement, the method comprising: receiving a request to transmit a capability report comprising a capability of the multi-antenna transmitter and receiver arrangement; obtaining the requested capability, the requested capability indicative of a first or second spatio-temporal dispersion the multi-antenna transmitter and receiver arrangement 420 (or the WD/TNode) is able to manage, the first spatio-temporal dispersion being smaller than the second spatio-temporal dispersion; and transmitting the capability report comprising the obtained capability.

According to some embodiments, the capability of the multi-antenna transmitter and receiver arrangement is indicative of the first spatio-temporal dispersion if the WD or the TNode is configured for carrier aggregation or dual connectivity and the capability of the multi-antenna transmitter and receiver arrangement is indicative of the second spatio-temporal dispersion if the WD or the TNode is configured to utilize a single bandwidth (SBW) or configured to utilize a single carrier.

According to some embodiments, the capability of the multi-antenna transmitter and receiver arrangement is changed from the first spatio-temporal dispersion to the second spatio-temporal dispersion or from the second spatio-temporal dispersion to the first spatio-temporal dispersion based on a condition, such as a detected overheating event or an overloading event.

According to some embodiments, the CA is a non-contiguous CA.

According to some embodiments, the DC is a non-contiguous DC.

According to some embodiments, the TNode is configured to utilize only one SBW.

According to some embodiments, the single carrier consists of only one carrier frequency.

According to some embodiments, the obtained capability is changed from the second spatio-temporal dispersion to the first spatio-temporal dispersion if the condition is one or more of a detected overheating event, and a detected overloading event.

According to some embodiments, the obtained capability is changed from the first spatio-temporal dispersion to the second spatio-temporal dispersion if the condition is one or more of a detected end of an overheating event, and a detected end of an overloading event.

According to some embodiments, the capability of the multi-antenna transmitter and receiver arrangement is indicative of the second spatio-temporal dispersion if the multi-antenna transmitter and receiver arrangement 420 (or the WD/TNode) is able to manage digital beamforming or is able to manage hybrid beamforming with a first number of transceivers, and the capability of the multi-antenna transmitter and receiver arrangement is indicative of the first spatio-temporal dispersion if the multi-antenna transmitter and receiver arrangement 420 (or the WD/TNode) is able to manage analog beamforming or is able to manage hybrid beamforming with a second number of transceivers, the second number being smaller than the first number, but not able (i.e., unable) to manage digital beamforming or hybrid beamforming with the first number of transceivers.

According to some embodiments, the capability of the multi-antenna transmitter and receiver arrangement is indicative of the first spatio-temporal dispersion if a frequency range configured for the WD or the TNode is equal to or above a threshold frequency and indicative of the second spatio-temporal dispersion if the frequency range configured for the WD or the TNode is below the threshold frequency.

According to some embodiments, the capability of the multi-antenna transmitter and receiver arrangement is indicative of the first spatio-temporal dispersion if a sub-carrier spacing configured for the WD or the TNode is above a sub-carrier spacing threshold and indicative of the second spatio-temporal dispersion if the sub-carrier spacing configured for the WD or the TNode is below or equal to the sub-carrier spacing threshold.

According to some embodiments, the capability of the multi-antenna transmitter and receiver arrangement is indicative of the first spatio-temporal dispersion if a number of MIMO layers configured for the WD or the TNode is above a MIMO layer number threshold and indicative of the second spatio-temporal dispersion if the number of MIMO layers configured for the WD or the TNode is below or equal to the MIMO layer number threshold.

According to some embodiments, the capability of the multi-antenna transmitter and receiver arrangement comprises one or more of a transmission capability of the multi-antenna transmitter and receiver arrangement and a reception capability of the multi-antenna transmitter and receiver arrangement.

According to some embodiments, the transmission capability of the multi-antenna transmitter and receiver arrangement is different from the reception capability of the multi-antenna transmitter and receiver arrangement.

According to a second aspect there is provided a computer program product comprising instructions, which, when executed on at least one processor of a processing device, cause the processing device to carry out the method according to the first aspect or any of the embodiments mentioned herein.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the embodiments mentioned herein.

According to a fourth aspect there is provided a wireless device (WD) comprising a multi-antenna transmitter and receiver arrangement and controlling circuitry configured to cause: reception of a request to transmit a capability report comprising a capability of the multi-antenna transmitter and receiver arrangement; obtainment of the requested capability, the requested capability indicative of a first or second spatio-temporal dispersion the multi-antenna transmitter and receiver arrangement 420 (or the WD/TNode) is able to manage, the first spatio-temporal dispersion being smaller than the second spatio-temporal dispersion; and transmission of the capability report comprising the obtained capability.

According to a fifth aspect there is provided a transceiver node (TNode) comprising a multi-antenna transmitter and receiver arrangement and controlling circuitry configured to cause: reception of a request to transmit a capability report comprising a capability of the multi-antenna transmitter and receiver arrangement; obtainment of the requested capability, the requested capability indicative of a first or second spatio-temporal dispersion the multi-antenna transmitter and receiver arrangement 420 (or the WD/TNode) is able to manage, the first spatio-temporal dispersion being smaller than the second spatio-temporal dispersion; and transmission of the capability report comprising the obtained capability.

Effects and features of the second, third, fourth, and fifth aspects are fully or to a substantial extent analogous to those described above in connection with the first aspect and vice versa. Embodiments mentioned in relation to the first aspect are fully or largely compatible with the second, third, fourth, and fifth aspects and vice versa.

An advantage of some embodiments is that the capacity of a wireless communication system is improved/increased (e.g., optimized).

Another advantage of some embodiments is a reduced power consumption for reception and/or transmission of data between transceiver nodes.

Yet another advantage of some embodiments, is that signaling of different capabilities for reception, transmission and/or different frequency ranges may reduce the complexity of the transceiver/chip design.

Another advantage of some embodiments is that capability can be dynamically adjusted upon detection of events in the wireless device/transceiver node.

A further advantage of some embodiments is that performance is improved or optimized.

Yet a further advantage of some embodiments is that complexity (of the implementation) is reduced (or minimized).

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Furthermore, the term “configured” or “adapted” is intended to mean that a unit or similar is shaped, sized, connected, connectable, programmed or otherwise adjusted for a purpose.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1 is a schematic drawing illustrating method steps according to some embodiments;

FIG. 2 is a schematic drawing illustrating a computer readable medium according to some embodiments;

FIG. 3 is a flowchart illustrating method steps implemented in a wireless device, a transceiver node or in a control unit/controlling circuitry associated therewith, according to some embodiments; and

FIG. 4 is a schematic drawing illustrating a system comprising remote transceiver nodes and a wireless device/transceiver node comprising a multi-antenna transmitter and receiver arrangement according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V2I) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, tablets, laptops, wireless stations, relays, repeater devices, reconfigurable intelligent surfaces, and large intelligent surfaces.

Below is referred to a “transceiver node” (TNode). A TNode may be a remote radio unit (RRU), a repeater, a remote wireless node, or a base station (BS), such as a radio base station (RBS), a Node B, an Evolved Node B (eNB) or a gNodeB (gNB). Furthermore, a TNode may be a BS for a neighboring cell, a BS for a handover (HO) candidate cell, a remote radio unit (RRU), a distributed unit (DU), another WD (a remote WD), a base station (BS) for a (active/deactivated) secondary cell (SCell) or for a serving/primary cell (PCell, e.g., associated with an active TCI state), a laptop, a wireless station, a relay, a repeater device, a reconfigurable intelligent surface, or a large intelligent surface.

Herein is referred to millimeter Wave (mmW) utilization, mmW communication, mmW communication capability and mmW frequency range. The mmW frequency range is from 24.25 Gigahertz (GHz) to 71 GHz or more generally from 24 to 300 GHz. MmW may also be referred to as Frequency Range 2 (FR2).

Below is referred to a digital interface. A digital interface is a unit converting analog signals from e.g., transceivers to digital signals, which digital signals are conveyed to e.g., a baseband processor, and/or converting digital signals from e.g., a baseband processor to analog signals, which analog signals are conveyed to e.g., one or more transceivers. A digital interface possible also comprises filters and other pre-processing functions/units.

Below is referred to an antenna unit. An antenna unit may be one single antenna. However, an antenna unit may also be a dual antenna, such as a dual patch antenna with a first (e.g., horizontal) and a second (e.g., vertical) polarization, thus functioning as two separate antennas or an antenna unit having two ports.

Herein is referred to a chip. A chip is an integrated circuit (chip) or a monolithic integrated circuit (chip) and may also be referred to as an IC, or a microchip.

Herein is referred to a “filter”. A filter is a device or process that removes some features, components, or frequencies from a signal.

Below is referred to “spatio-temporal dispersion”. Spatio-temporal dispersion comprises spatial dispersion and/or temporal dispersion. Spatial dispersion (dispersion in space) may be defined as the number of spatial directions in which the transceiver can simultaneously transmit and/or receive. Thus, spatial dispersion represents scattering or spreading effects (originating from reflections of the transmitted radio wave at objects). Temporal dispersion, i.e., dispersion in time, represents memory effects in systems.

Herein is referred to “analog beamforming”, “hybrid beamforming” and “digital beamforming”. Digital beamforming means that the beamforming processing, e.g., multiplication of a coefficient, is performed before digital to analog conversion (DAC) for transmission (and after analog to digital conversion, ADC, for reception), i.e., in the digital domain. Analog beamforming means that the beamforming processing, e.g., phase shifting, is performed after DAC for transmission (and before ADC for reception), i.e., in the analog domain. Hybrid beamforming means that some beamforming processing, e.g., phase shifting, is performed after DAC and some beamforming processing, e.g., multiplication of a coefficient, is performed before DAC for transmission (and before and after ADC for reception), i.e., processing in both digital and analog domains.

Herein is referred to an overloading event. An overloading event occurs when it is detected (by the wireless device or control circuitry thereof) that the processing power required is larger than the (processing power) capability, e.g., there are too many processes in the chip/wireless device ongoing simultaneously).

Herein is referred to an overheating event. An overheating event occurs when one or more temperature sensors indicates a temperature, in the wireless device or in a component thereof, which is above an overheating threshold (temperature).

### Basic Concept

A basic concept of the invention is to perform capability signalling for a multi-antenna transmitter and receiver arrangement, such as a multi-antenna transceiver arrangement, comprised in a WD or a TNode. The multi-antenna transmitter and receiver arrangement capability comprises capability (information) to handle spatial-temporal dispersion of the radio channel utilized for communication with a remote TNode. As an example, the capability may specify the number of spatial directions the multi-antenna transmitter and receiver arrangement is able to simultaneously transmit and/or receive in. Furthermore, the capability may be adapted based on obtained overload/overheating events (e.g., associated with/caused by processing performed by the WD/TNode). Moreover, the capability (information) is transmitted to a remote Tnode.

### Embodiments

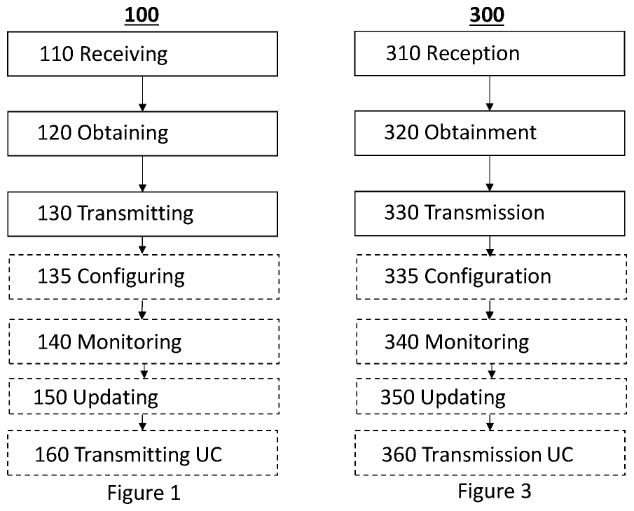

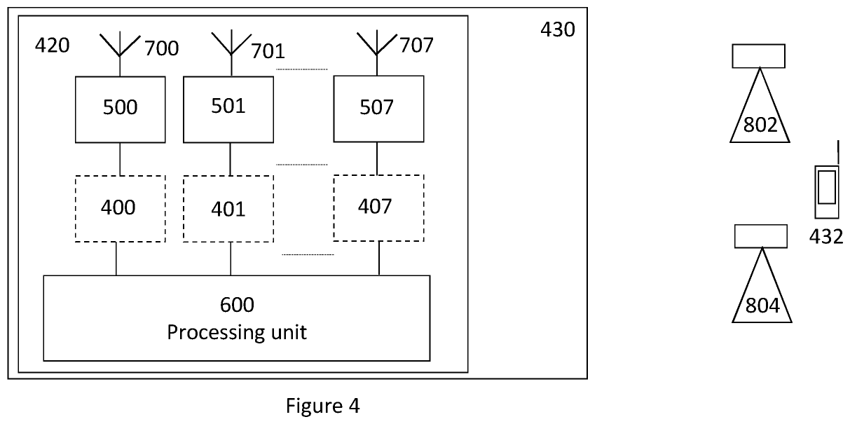

In the following, embodiments will be described where FIG. 1 illustrates method steps according to some embodiments. The method 100 is for a wireless device (WD) or for a transceiver node (TNode). The WD or the TNode comprises a multi-antenna transmitter and receiver arrangement 420 (shown in FIG. 4). The method 100 comprises receiving 110, e.g., from a remote TNode, a request to transmit a capability report comprising a capability of the multi-antenna transmitter and receiver arrangement 420 (i.e., capability information specifying a certain capability/ability the multi-antenna transmitter and receiver arrangement 420 has). In some embodiments, the request is transmitted in a radio resource control (RRC) message, such as an RRC reconfiguration message. The RRC message may be transmitted in connection with an RRC connection setup message. In some embodiments, the request is transmitted on the Medium Access (MAC) or the physical (Phy) Layer in a radio access network (RAN). Furthermore, the method 100 comprises obtaining 120 the requested capability (of the multi-antenna transmitter and receiver arrangement 420). The requested capability is indicative of a first or a second spatio-temporal dispersion the multi-antenna transmitter and receiver arrangement 420 (or the WD/TNode) is able to manage, i.e., the highest spatio-temporal dispersion the multi-antenna transmitter and receiver arrangement 420 (or the WD/TNode) is able to manage. Thus, in some embodiments, a first capability is indicative of a first spatio-temporal dispersion and a second capability is indicative of a second spatio-temporal dispersion. In some embodiments, the requested capability is indicative of a first, a second or a third spatio-temporal dispersion the multi-antenna transmitter and receiver arrangement 420 (or the WD/TNode) is able to manage. The first spatio-temporal dispersion is smaller than the second spatio-temporal dispersion. The second spatio-temporal dispersion is smaller than the third spatio-temporal dispersion. In some embodiments, obtaining 120 the requested capability is based on the number of transceiver chains, transceivers and/or antennas comprised in the WD/TNode. Alternatively, the requested capability is pre-configured/pre-registered in a look-up table (LUT) comprised in the WD/TNode, i.e., the WD/TNode comprises an LUT comprising the requested capability. Moreover, the method 100 comprises transmitting 130 the capability report comprising the obtained capability, e.g., to the remote TNode. In some embodiments, each possible capability is expressed as a number of an index or a key in a look-up table (LUT) associated with the capability (both at the WD/TNode and at the remote TNode). Thus, only a number/key (for the present capability) needs to be transmitted. Thereby, less data needs to be transmitted.

In some embodiments, the capability report is transmitted via RRC (i.e., utilizing the RRC protocol; i.e., over the network layer). However, in some embodiments, the capability report is transmitted on the MAC or Phy Layer in RAN. As an example, the MAC or Phy Layer can be utilized if the WD needs to change capability quickly, due to various reasons such as intermittent computation or power limitations of the WD, or due to fast radio resource load changes in the wireless communication system. When there is a need for a fast change of capabilities, the utilization of MAC or Phy layer may improve radio resource utilization, e.g., improve efficiency, and/or reduce latency.

In some embodiments, the capability report is transmitted in control messages on different OSI layers, e.g., some capability information is transmitted on RRC while other capability information is transmitted on MAC layer. Transmitting capability information important for respective protocol layer on the respective protocol layer reduces the overhead signalling between different layers, thereby improving the functionality and increasing capacity in the communication system.

In some embodiments, the capability of the multi-antenna transmitter and receiver arrangement 420 is indicative of the second spatio-temporal dispersion if the multi-antenna transmitter and receiver arrangement 420 (or the WD/TNode) is able to manage digital beamforming or is able to manage hybrid beamforming with a first number of transceivers (i.e., a second capability) and the capability of the multi-antenna transmitter and receiver arrangement 420 is indicative of the first spatio-temporal dispersion if the multi-antenna transmitter and receiver arrangement 420 (or the WD/TNode) is able to manage analog beamforming or is able to manage hybrid beamforming with a second number of transceivers, but not able (i.e., unable) to manage digital beamforming or hybrid beamforming with the first number of transceivers (i.e., a first capability). The second number of transceivers may be smaller than the first number of transceivers. In some embodiments, the capability of the multi-antenna transmitter and receiver arrangement 420 is in the capability report set to one or more of “digital beamforming”, “hybrid beamforming with X or more transceivers”, “hybrid beamforming with less than X transceivers” or “analog beamforming”, where X may be a number such as 1, 2, 4, 8 or 16 (and where X=1 may mean analog beamforming). Alternatively, indexing of the possible capabilities is performed so that, e.g., for “digital beamforming” a “00” is included in the capability report, for “hybrid beamforming with X or more transceivers” a “01” is included in the capability report, for “hybrid beamforming with less than X transceivers” a “10” is included in the capability report and for “analog beamforming” a “11” is included in the capability report.

Alternatively, the capability of the multi-antenna transmitter and receiver arrangement 420 is indicative of the first spatio-temporal dispersion if a communication frequency range configured (e.g., by the remote TNode) for the WD or the TNode is equal to or above a communication frequency range threshold and indicative of the second spatio-temporal dispersion if the communication frequency range configured for the WD or the TNode is below the communication frequency range threshold. I.e., the capability of the multi-antenna transmitter and receiver arrangement 420 is indicative of the first spatio-temporal dispersion if the WD/TNode is configured (e.g., by the WD/TNode, the system or a remote TNode) to utilize a communication frequency range which is equal to or above a communication frequency range threshold and indicative of the second spatio-temporal dispersion if the WD/TNode is configured to utilize a communication frequency range which is below the communication frequency range threshold. As an example, the communication frequency range threshold is 400 Megahertz (MHz). In some embodiments a communication frequency range is or comprises a configured bandwidth part/portion.

As a further alternative, the capability of the multi-antenna transmitter and receiver arrangement 420 is indicative of the first spatio-temporal dispersion if a carrier frequency configured (e.g., by the remote TNode) for the WD or the TNode is equal to or above a carrier frequency threshold and indicative of the second spatio-temporal dispersion if the carrier frequency configured for the WD or the TNode is below the carrier frequency threshold. I.e., the capability of the multi-antenna transmitter and receiver arrangement 420 is indicative of the first spatio-temporal dispersion if the WD/TNode is configured (e.g., by the WD/TNode, the system or a remote TNode) to utilize a carrier frequency which is equal to or above a carrier frequency threshold and indicative of the second spatio-temporal dispersion if the WD/TNode is configured to utilize a carrier frequency which is below the carrier frequency threshold. As an example, the carrier frequency threshold is 51 Gigahertz (GHz). As another example the carrier frequency threshold is 12 GHz.

As yet a further alternative, the capability of the multi-antenna transmitter and receiver arrangement 420 is based on in how many spatial directions the multi-antenna transmitter and receiver arrangement 420 can simultaneously transmit and/or receive. Thus, in some embodiments, the capability of the multi-antenna transmitter and receiver arrangement 420 is indicative of the first spatio-temporal dispersion if the multi-antenna transmitter and receiver arrangement 420 (or the WD/TNode) is able to transmit and/or receive in a number of spatial directions which is equal to or above a number of spatial direction threshold and indicative of the second spatio-temporal dispersion if the multi-antenna transmitter and receiver arrangement 420 (or the WD/TNode) is able to transmit and/or receive in a number of spatial directions which is below the number of spatial direction threshold. As an example, the spatial direction threshold is 2. As another example, the spatial direction threshold is 3. Additionally, or alternatively, the capability is indicative or comprises information (for each spatial direction the WD/TNode/multi-antenna transmitter and receiver arrangement 420 is able to transmit and/or receive in) about how wide the beam is, i.e., information about beamwidth. Such indications/information may be expressed as wider than a threshold angle or narrower than the threshold angle. As an example, the threshold angle is 120 degrees (of 360 degrees). As another example the threshold angle is 10 degrees. As yet another example the threshold angle is 24 degrees. Alternatively, the indications/information is expressed as an approximate angle/beamwidth of each beam. As an example, the angle/beamwidth is 120 degrees (of 360 degrees). As another example the angle/beamwidth is 10 degrees. As yet another example the angle/beamwidth is 24 degrees. As yet another alternative, the indications/information is expressed as a first and a second approximate angle/beamwidth of the/each beam, e.g., for 3D MIMO (e.g., the first for vertical direction and the second for horizontal direction). As an example, the first/vertical angle/beamwidth is 4.8 degrees, and the second/horizontal angle/beamwidth is 27 degrees. As a further alternative, the indications/information is expressed as a minimum resolution between 2 different spatial directions that needs to be met in order to distinguish between the 2 different spatial directions (and not count the 2 different spatial directions of the multi-antenna transmitter and receiver arrangement 420 as only one spatial direction).

As another alternative, the capability of the multi-antenna transmitter and receiver arrangement 420 is indicative of the first spatio-temporal dispersion if a sub-carrier spacing configured for the WD or the TNode to use is above a sub-carrier spacing threshold and indicative of the second spatio-temporal dispersion if the sub-carrier spacing configured for the WD or the TNode is below or equal to the sub-carrier spacing threshold. I.e., the capability of the multi-antenna transmitter and receiver arrangement 420 is indicative of the first spatio-temporal dispersion if the WD/TNode is configured to have a sub-carrier spacing which is above a sub-carrier spacing threshold and indicative of the second spatio-temporal dispersion if the WD/TNode is configured to have a sub-carrier spacing which is below or equal to the sub-carrier spacing threshold. As an example, the sub-carrier spacing threshold is 60 Kilohertz (KHz). As an example, the sub-carrier spacing threshold is 120 KHz. Other examples of the sub-carrier spacing threshold are 15, 30, 60 and 240 KHz. Sub-carrier spacing (SCS) is in 5G-NR related to symbol time/rate and if the symbol time is short, i.e., a large SCS, a transceiver may not be able to handle as many spatial directions as if SCS is small.

As yet another alternative, the capability of the multi-antenna transmitter and receiver arrangement 420 is indicative of the first spatio-temporal dispersion if a number of MIMO layers configured for the WD or the TNode is above a MIMO layer number threshold and indicative of the second spatio-temporal dispersion if the number of MIMO layers configured for the WD or the TNode is below or equal to the MIMO layer number threshold. I.e., the capability of the multi-antenna transmitter and receiver arrangement 420 is indicative of the first spatio-temporal dispersion if the WD/TNode is configured for a number of MIMO layers which is above a MIMO layer number threshold and indicative of the second spatio-temporal dispersion if the WD/TNode is configured for a number of MIMO layers which is below or equal to the MIMO layer number threshold. As an example, the number of MIMO layers threshold may be 2.

As a further alternative, the capability of the multi-antenna transmitter and receiver arrangement 420 is indicative of the first spatio-temporal dispersion if the WD or the TNode is configured for carrier aggregation (CA) or dual connectivity (DC) utilization and the capability of the multi-antenna transmitter and receiver arrangement 420 is indicative of the second spatio-temporal dispersion if the WD or the TNode is configured for a single bandwidth (SBW), e.g., configured for only one SBW, or configured for single carrier utilization, e.g., configured to utilize only one carrier frequency. In some embodiments, the CA is a non-contiguous CA. Furthermore, in some embodiments, the DC is a non-contiguous DC. Alternatively, the CA/DC is a contiguous CA/DC. Contiguous (CA/DC) refers to two or more adjacent carriers forming one single block of radio spectrum, allowing the network to treat the aggregated frequency band as a single enlarged channel. Non-contiguous (CA/DC) refers to two or more adjacent carriers not forming a single block of radio spectrum; thus, the network has to process/treat two separate frequency bands. Moreover, in some embodiments, the WD/TNode is configured to utilize only one SBW, e.g., if the CA/DC is a contiguous CA/DC. In some embodiments, the single carrier consists of only one carrier frequency, e.g., if the CA/DC is a contiguous CA/DC. As yet a further alternative, the capability of the multi-antenna transmitter and receiver arrangement 420 is indicative of the second spatio-temporal dispersion if the WD or the TNode is not configured for non-contiguous CA or is configured to utilize a contiguous CA bandwidth below or equal to a CA bandwidth threshold and the capability of the multi-antenna transmitter and receiver arrangement 420 is indicative of the first spatio-temporal dispersion if the WD or the TNode is configured for non-contiguous CA or is configured to utilize a contiguous CA bandwidth above the CA bandwidth threshold. As an example, the CA bandwidth threshold is 400 MHZ.

Furthermore, in some embodiments, the capability of the multi-antenna transmitter and receiver arrangement 420 is changed from (indicating) the first spatio-temporal dispersion to (indicating) the second spatio-temporal dispersion or from (indicating) the second spatio-temporal dispersion to (indicating) the first spatio-temporal dispersion based on a condition. In some embodiments, the condition is a channel condition, a signal condition, an internal state condition. Preferably, the condition is one or more of a detected overheating event, a detected overloading event, a detected end of an overheating event or a detected end of an overloading event, e.g., one or more of a detected overheating event, and a detected overloading event or one or more of a detected end of an overheating event and a detected end of an overloading event. Typically, a transceiver and/or processor requires more processing power for a dispersive (radio) channel than for a less dispersive (radio) channel (depending on operations or configurations needed in the WD which may be dependent on the present communication/activity, e.g., playing games or video). Therefore, it may be difficult to optimally handle dispersive channels. Thus, it may be beneficial to detect overheating/overloading events and report a change of capability, e.g., the WD/multi-antenna transmitter and receiver arrangement 420 is (presently) able to handle only the first spatio-temporal dispersion and not the second spatio-temporal dispersion (due to an overheating/overloading event). Such capability changes are preferably transmitted as UE assistance information on the RRC layer, but may additionally, or alternatively, be transmitted via MAC or physical layer signalling. In some embodiments, the obtained capability is changed from the second spatio-temporal dispersion to the first spatio-temporal dispersion if the condition is one or more of a detected overheating event, and a detected overloading event. Furthermore, in some embodiments, the obtained capability is changed from the first spatio-temporal dispersion to the second spatio-temporal dispersion if the condition is one or more of a detected end of an overheating event, and a detected end of an overloading event. Moreover, in some embodiments, the capability of the multi-antenna transmitter and receiver arrangement 420 comprises one or more of a transmission capability of the multi-antenna transmitter and receiver arrangement 420 and a reception capability of the multi-antenna transmitter and receiver arrangement 420. In some embodiments, the transmission capability of the multi-antenna transmitter and receiver arrangement 420 is different from the reception capability of the multi-antenna transmitter and receiver arrangement 420. However, in some embodiments, the transmission capability of the multi-antenna transmitter and receiver arrangement 420 is the same as the reception capability of the multi-antenna transmitter and receiver arrangement 420. The transmission capability and/or the reception capability may be categorized the same way as the capability of the multi-antenna transmitter and receiver arrangement 420, e.g., able to manage analog beamforming (only), able to manage hybrid beamforming with a second number of transceivers (only), able to manage digital beamforming or able to manage hybrid beamforming with the first number of transceivers. Alternatively, the transmission capability and/or the reception capability is based on in how many spatial directions the multi-antenna transmitter and receiver arrangement 420 can simultaneously transmit and/or receive (as described above). As yet another alternative, the transmission capability and/or the reception capability is based on communication frequency range, carrier frequency, sub-carrier spacing, number of MIMO layers, carrier aggregation (CA), dual connectivity (DC) utilization, non-contiguous CA, CA bandwidth and/or overheating/overloading events as described above.

In some embodiments, the method 100 comprises monitoring 140 configurations, e.g., the capability of the multi-antenna transmitter and receiver arrangement 420, the transmission capability and/or the reception capability, and events, e.g., overheating events and/or overloading events. Furthermore, in some embodiments, if a change in a configuration is detected or if an event occurs, the method 100 comprises updating 150 the capability of the multi-antenna transmitter and receiver arrangement 420 and transmitting 160 the updated capability to the remote transceiver node (without first receiving a request to do so). If no change in a configuration is detected and no event occurs, the method 100 comprises continuing monitoring 140. In some embodiments, the steps of monitoring 140, updating 150 and transmitting 160 are performed because the WD/TNode is configured to send user equipment (UE) assistance information (a 5G NR radio resource control, RRC, procedure) to the network, i.e., the WD/TNode may assist a remote Tnode with the current/updated capability of the multi-antenna transmitter and receiver arrangement 420. Thus, in some embodiments, the method 100 comprises configuring 135 the WD/TNode to send UE assistance information to the remote TNode. In some embodiments, transmitting 160 the updated capability to the remote TNode comprises transmitting UE assistance information comprising the updated capability to the remote TNode. In some embodiments, configuring 135 is performed as a response to a request from a remote TNode. Such a request may be transmitted in a radio resource control (RRC) message, such as an RRC reconfiguration message. The RRC message may be transmitted in connection with an RRC connection setup message.

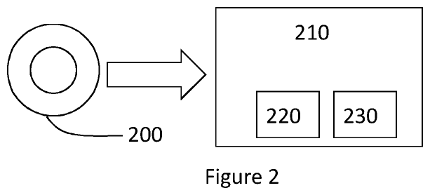

According to some embodiments, a computer program product comprising a non-transitory computer readable medium 200, such as a punch card, a compact disc (CD) ROM, a read only memory (ROM), a digital versatile disc (DVD), an embedded drive, a plug-in card, a random access memory (RAM) or a universal serial bus (USB) memory, is provided. FIG. 2 illustrates an example computer readable medium in the form of a compact disc (CD) ROM 200. The computer readable medium has stored thereon, a computer program comprising program instructions. The computer program is loadable into a data processor (PROC) 220, which may, for example, be comprised in a computer 210 or a computing device or a control unit. When loaded into the data processor, the computer program may be stored in a memory (MEM) 230 associated with or comprised in the data processor. According to some embodiments, the computer program may, when loaded into and run by the data processor, cause execution of method steps according to, for example, the method illustrated in FIG. 1, which is described herein. Furthermore, in some embodiments, there is provided a computer program product comprising instructions, which, when executed on at least one processor of a processing device, cause the processing device to carry out the method illustrated in FIG. 1. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1.

FIG. 3 illustrates method steps implemented in a multi-antenna transmitter and receiver arrangement 420 (or in a control unit or controlling circuitry comprised therein or associated therewith, e.g., a processing unit, and configured to control the multiple antenna transceiver system 420) according to some embodiments. The multi-antenna transmitter and receiver arrangement 420 comprises controlling circuitry. Alternatively, a WD or a TNode comprising the multi-antenna transmitter and receiver arrangement 420 comprises the controlling circuitry. The controlling circuitry causes or is configured to cause reception 310 of a request to transmit a capability report comprising a capability of the multi-antenna transmitter and receiver arrangement 420. To this end, the controlling circuitry may be associated with (e.g., operatively connectable, or connected, to) a reception unit (e.g., receiving circuitry or receivers or transceivers 500, 501, . . . , 515 and associated antenna units 700, 701, . . . , 715). Furthermore, the controlling circuitry causes or is configured to cause obtainment 320 of the requested capability. The requested capability is indicative of a first or second spatio-temporal dispersion the multi-antenna transmitter and receiver arrangement 420 (or the WD/TNode) is able to manage. The first spatio-temporal dispersion is smaller than the second spatio-temporal dispersion. To this end, the controlling circuitry may be associated with (e.g., operatively connectable, or connected, to) a first obtainment unit (e.g., first obtaining circuitry, a first obtainer or the processing unit 600 shown in FIG. 4). Moreover, the controlling circuitry causes or is configured to cause transmission 330 of the capability report comprising the obtained capability. To this end, the controlling circuitry may be associated with (e.g., operatively connectable, or connected, to) one or more transmission units (e.g., transmitting circuitry or transmitters or transceivers 500, 501, . . . , 515 and associated antenna units 700, 701, . . . , 715). In some embodiments, the controlling circuitry causes or is configured to cause monitoring 340 of configurations, e.g., the capability of the multi-antenna transmitter and receiver arrangement 420, the transmission capability and/or the reception capability, and of events, e.g., overheating events and/or overloading events (until a change occurs). To this end, the controlling circuitry may be associated with (e.g., operatively connectable, or connected, to) a monitoring unit (e.g., monitoring circuitry or a monitor or the processing unit 600 shown in FIG. 4). Furthermore, in some embodiments, the controlling circuitry causes or is configured to cause updating 350 of the capability of the multi-antenna transmitter and receiver arrangement 420 if a change in a configuration is detected or if an event occurs. To this end, the controlling circuitry may be associated with (e.g., operatively connectable, or connected, to) an updating unit (e.g., updating circuitry or an updater or the processing unit 600 shown in FIG. 4). Moreover, in some embodiments, the controlling circuitry causes or is configured to cause transmission 360 of the updated capability to the remote transceiver node (without first receiving a request to do so). In some embodiments, the steps of monitoring 340, updating 350 and transmission 360 are performed since the WD/TNode is configured to send UE assistance information to the network, i.e., the WD/TNode may assist a remote Tnode with the current/updated capability of the multi-antenna transmitter and receiver arrangement 420. Thus, in some embodiments, the method 100 comprises configuration 335 of the WD/TNode to send UE assistance information to the remote TNode.

FIG. 4 illustrates a system comprising a wireless device (WD) 430 (or a TNode) and remote Tnodes 432, 802, 804 according to some embodiments. The remote TNode 432 is a WD. The WD 430 comprises a multi-antenna transmitter and receiver arrangement 420. The multi-antenna transmitter and receiver arrangement 420 (or the WD 430 or the TNode) comprises a processing unit 600, a control unit or similar controlling circuitry. Furthermore, the processing unit 600 is connected or connectable to a plurality of transceivers 500, . . . , 507 directly or via one or more digital interfaces 400, . . . , 407. Moreover, in some embodiments, each transceiver 500, . . . , 507 is connected to one or more antennas 700, . . . , 707. In some embodiments, the multi-antenna transmitter and receiver arrangement 420 comprises the transceivers 500, . . . , 507, the processing unit 600 and optionally the digital interfaces 400, . . . , 407 and/or the one or more antennas 700, . . . , 707. Alternatively, in some embodiments, the multi-antenna transmitter and receiver arrangement 420 comprises the transceivers 500, . . . , 507, and optionally the digital interfaces 400, . . . , 407 and/or the one or more antennas 700, . . . , 707 and the WD 430 (or the TNode) comprises the processing unit 600. In some embodiments, the digital interfaces 400, . . . , 407 are comprised in a respective transceiver 500, . . . , 507). In some embodiments, the digital interfaces 400, . . . , 407 are comprised in the processing unit 600. The WD 430 is able/configurable/configured to communicate with (transmit to and receive from) the remote TNodes 432, 802, 804 (via antennas 700, . . . , 707 and transceivers 500, . . . , 507). Thus, the WD 430 may receive a request, from a remote TNode 432, 802, 804, to transmit a capability report comprising a capability of the multi-antenna transmitter and receiver arrangement 420 from a remote TNode 432, 802, 804. Furthermore, the WD 430 (or the processing unit 600) may obtain the requested capability. Moreover, the WD 430 may transmit the capability report comprising the obtained capability, e.g., to the remote TNode 432, 802, 804.

### LIST OF EXAMPLES

### Example 1

A method (100) for a wireless device, WD, or a transceiver node, TNode, comprising a multi-antenna transmitter and receiver arrangement (420), the method comprising:
receiving (110) a request to transmit a capability report comprising a capability of the multi-antenna transmitter and receiver arrangement (420);
obtaining (120) the requested capability, the requested capability indicative of a first or second spatio-temporal dispersion the multi-antenna transmitter and receiver arrangement (420) is able to manage, the first spatio-temporal dispersion being smaller than the second spatio-temporal dispersion; and
transmitting (130) the capability report comprising the obtained capability.

### Example 2

The method of example 1, wherein the capability of the multi-antenna transmitter and receiver arrangement (420) is indicative of the second spatio-temporal dispersion if the WD or the TNode is able to manage digital beamforming or is able to manage hybrid beamforming with a first number of transceivers, and wherein the capability of the multi-antenna transmitter and receiver arrangement (420) is indicative of the first spatio-temporal dispersion if the WD or the TNode is able to manage analog beamforming or is able to manage hybrid beamforming with a second number of transceivers, the second number being smaller than the first number, but not able to manage digital beamforming or hybrid beamforming with the first number of transceivers.

### Example 3

The method of example 1, wherein the capability of the multi-antenna transmitter and receiver arrangement (420) is indicative of the first spatio-temporal dispersion if a frequency range configured for the WD or the TNode is equal to or above a threshold frequency and indicative of the second spatio-temporal dispersion if the frequency range configured for the WD or the TNode is below the threshold frequency.

### Example 4

The method of example 1, wherein the capability of the multi-antenna transmitter and receiver arrangement (420) is indicative of the first spatio-temporal dispersion if a sub-carrier spacing configured for the WD or the TNode is above a sub-carrier spacing threshold and indicative of the second spatio-temporal dispersion if the sub-carrier spacing configured for the WD or the TNode is below or equal to the sub-carrier spacing threshold.

### Example 5

The method of example 1, wherein the capability of the multi-antenna transmitter and receiver arrangement (420) is indicative of the first spatio-temporal dispersion if a number of MIMO layers configured for the WD or the TNode is above a MIMO layer number threshold and indicative of the second spatio-temporal dispersion if the number of MIMO layers configured for the WD or the TNode is below or equal to the MIMO layer number threshold.

### Example 6

The method of example 1, wherein the capability of the multi-antenna transmitter and receiver arrangement (420) is indicative of the first spatio-temporal dispersion if the WD or the TNode is configured for carrier aggregation or dual connectivity and wherein the capability of the multi-antenna transmitter and receiver arrangement (420) is indicative of the second spatio-temporal dispersion if the WD or the TNode is configured to utilize a single bandwidth, SBW, or a single carrier.

### Example 7

The method of any of examples 1-6, wherein the capability of the multi-antenna transmitter and receiver arrangement (420) is changed from the first spatio-temporal dispersion to the second spatio-temporal dispersion or from the second spatio-temporal dispersion to the first spatio-temporal dispersion based on a condition, such as a detected overheating event or an overloading event.

### Example 8

The method of any of examples 1-7, wherein the capability of the multi-antenna transmitter and receiver arrangement (420) comprises one or more of a transmission capability of the multi-antenna transmitter and receiver arrangement (420) and a reception capability of the multi-antenna transmitter and receiver arrangement (420) and wherein the transmission capability of the multi-antenna transmitter and receiver arrangement (420) is different from the reception capability of the multi-antenna transmitter and receiver arrangement (420).

### Example 9

A computer program product comprising a non-transitory computer readable medium (200), having stored thereon a computer program comprising program instructions, the computer program being loadable into a data processing unit (220) and configured to cause execution of the method of any of examples 1-8 when the computer program is run by the data processing unit.

### Example 10

A wireless device, WD, comprising a multi-antenna transmitter and receiver arrangement (420) and controlling circuitry configured to cause:
reception (310) of a request to transmit a capability report comprising a capability of the multi-antenna transmitter and receiver arrangement (420);
obtainment (320) of the requested capability, the requested capability indicative of a first or second spatio-temporal dispersion the multi-antenna transmitter and receiver arrangement (420) is able to manage, the first spatio-temporal dispersion being smaller than the second spatio-temporal dispersion; and
transmission (330) of the capability report comprising the obtained capability.

### Example 11

A transceiver node, TNode, comprising a multi-antenna transmitter and receiver arrangement (420) and controlling circuitry configured to cause:
reception (310) of a request to transmit a capability report comprising a capability of the multi-antenna transmitter and receiver arrangement (420);
obtainment (320) of the requested capability, the requested capability indicative of a first or second spatio-temporal dispersion the multi-antenna transmitter and receiver arrangement (420) is able to manage, the first spatio-temporal dispersion being smaller than the second spatio-temporal dispersion; and
transmission (330) of the capability report comprising the obtained capability.

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A method for a wireless device (WD) or a transceiver node (TNode) comprising a multi-antenna transmitter and receiver arrangement, the method comprising:
receiving a request to transmit a capability report comprising a capability of the multi-antenna transmitter and receiver arrangement;
obtaining the requested capability, wherein the requested capability is indicative of a first spatio-temporal dispersion or a second spatio-temporal dispersion the multi-antenna transmitter and receiver arrangement is able to manage, wherein each of the first and second spatio-temporal dispersions is associated with the number of spatial directions in which the WD or the Tnode can simultaneously transmit and/or receive, and wherein the first spatio-temporal dispersion is smaller than the second spatio-temporal dispersion; and
transmitting the capability report comprising the obtained capability,
wherein the obtained capability is indicative of the first spatio-temporal dispersion if the WD or the TNode is configured for carrier aggregation (CA) or dual connectivity (DC) and wherein the obtained capability is indicative of the second spatio-temporal dispersion if the WD or the TNode is configured to utilize a single bandwidth (SBW) or a single carrier.

2. The method of claim 1, wherein the CA is a non-contiguous CA.

3. The method of claim 1, wherein the DC is a non-contiguous DC.

4. The method of claim 2, wherein the TNode is configured to utilize only one SBW.

5. The method of claim 2, wherein the single carrier consists of only one carrier frequency.

6. The method of claim 1, wherein the obtained capability is changed from the second spatio-temporal dispersion to the first spatio-temporal dispersion or from the second spatio-temporal dispersion to the first spatio-temporal dispersion based on a condition, and wherein the obtained capability is changed from the second spatio-temporal dispersion to the first spatio-temporal dispersion if the condition is a detected overloading event.

7. The method of claim 1, wherein the obtained capability is changed from the first spatio-temporal dispersion to the second spatio-temporal dispersion or from the second spatio-temporal dispersion to the first spatio-temporal dispersion based on a condition, and wherein the obtained capability is changed from the first spatio-temporal dispersion to the second spatio-temporal dispersion if the condition is one or more of a detected end of an overheating event, and a detected end of an overloading event.

8. The method of claim 1, wherein the capability of the multi-antenna transmitter and receiver arrangement is indicative of the second spatio-temporal dispersion if the WD or the TNode is able to manage digital beamforming or is able to manage hybrid beamforming with a first number of transceivers, and wherein the capability of the multi-antenna transmitter and receiver arrangement is indicative of the first spatio-temporal dispersion if the WD or the TNode is able to manage analog beamforming or is able to manage hybrid beamforming with a second number of transceivers, the second number being smaller than the first number, but unable to manage digital beamforming or hybrid beamforming with the first number of transceivers.

9. The method of claim 1, wherein the capability of the multi-antenna transmitter and receiver arrangement is indicative of the first spatio-temporal dispersion if a frequency range configured for the WD or the TNode is equal to or above a threshold frequency and indicative of the second spatio-temporal dispersion if the frequency range configured for the WD or the TNode is below the threshold frequency.

10. The method of claim 1, wherein the capability of the multi-antenna transmitter and receiver arrangement is indicative of the first spatio-temporal dispersion if a sub-carrier spacing configured for the WD or the TNode is above a sub-carrier spacing threshold and indicative of the second spatio-temporal dispersion if the sub-carrier spacing configured for the WD or the TNode is below or equal to the sub-carrier spacing threshold.

11. The method of claim 1, wherein the capability of the multi-antenna transmitter and receiver arrangement is indicative of the first spatio-temporal dispersion if a number of multiple-input multiple-output (MIMO) layers configured for the WD or the TNode is above a MIMO layer number threshold and indicative of the second spatio-temporal dispersion if the number of MIMO layers configured for the WD or the TNode is below or equal to the MIMO layer number threshold.

12. The method of claim 1, wherein the capability of the multi-antenna transmitter and receiver arrangement comprises one or more of a transmission capability of the multi-antenna transmitter and receiver arrangement and a reception capability of the multi-antenna transmitter and receiver arrangement and wherein the transmission capability of the multi-antenna transmitter and receiver arrangement is different from the reception capability of the multi-antenna transmitter and receiver arrangement.

13. (canceled)

14. A non-transitory computer-readable storage medium storing one or more programs configured to be executed by one or more processors of a processing device, the one or more programs comprising instructions which, when executed by the processing device, causes the processing device to carry out the method according to claim 1.

15. A device, wherein the device is a wireless device (WD) or a transceiver node (TNode), comprising a multi-antenna transmitter and receiver arrangement and controlling circuitry configured to cause:
reception of a request to transmit a capability report comprising a capability of the multi-antenna transmitter and receiver arrangement;
obtainment of the requested capability, wherein the requested capability is indicative of a first or second spatio-temporal dispersion the multi-antenna transmitter and receiver arrangement is able to manage, wherein each of the first and second spatio-temporal dispersions is associated with the number of spatial directions in which the WD or the Tnode can simultaneously transmit and/or receive, and wherein the first spatio-temporal dispersion is smaller than the second spatio-temporal dispersion; and
transmission of the capability report comprising the obtained capability,
wherein the obtained capability is indicative of the first spatio-temporal dispersion if the WD or the TNode is configured for carrier aggregation (CA) or dual connectivity (DC) and wherein the obtained capability is indicative of the second spatio-temporal dispersion if the WD or the TNode is configured to utilize a single bandwidth (SBW) or a single carrier.

16. The device of claim 15, wherein the CA is a non-contiguous CA.

17. The device of claim 15, wherein the DC is a non-contiguous DC.

18. The device of claim 17, wherein the TNode is configured to utilize only one SBW.

19. The device of claim 17, wherein the single carrier consists of only one carrier frequency.

20. The device of claim 15, wherein the obtained capability is changed from the first spatio-temporal dispersion to the second spatio-temporal dispersion or from the second spatio-temporal dispersion to the first spatio-temporal dispersion based on a condition, and wherein the obtained capability is changed from the second spatio-temporal dispersion to the first spatio-temporal dispersion if the condition is one or more of a detected overheating event, and a detected overloading event.

21. The device of claim 15, wherein the obtained capability is changed from the first spatio-temporal dispersion to the second spatio-temporal dispersion or from the second spatio-temporal dispersion to the first spatio-temporal dispersion based on a condition, and wherein the obtained capability is changed from the first spatio-temporal dispersion to the second spatio-temporal dispersion if the condition is one or more of a detected end of an overheating event, and a detected end of an overloading event.

22-28. (canceled)
